(19) United States
(12) Patent Application Publication
(10) Pub. No.: US 2015/0242967 A1
(43) Pub. Date: Aug. 27, 2015

(54) GENERATING MEMBER PROFILE RECOMMENDATIONS BASED ON COMMUNITY OVERLAP DATA IN A SOCIAL GRAPH

(71) Applicant: Linkedln Corporation, Mountain View, CA (US)

(72) Inventor: Samir M. Shsh, San Francisco, CA (US)

(73) Assignee: LinkedIn Corporation, Mountain View, CA (US)

(21) Appl. No.: 14/192,010

(22) Filed: Feb. 27, 2014

(51) Int. Cl. G06Q 50/00; G06Q 10/10

(52) U.S. Cl. CPC G06Q 50/01; G06Q 10/105

(57) ABSTRACT

Systems and methods for generating recommendations based on data derived from a social network are described. For example, a community in a social network service to which a plurality of member profiles belongs may be selected. A first prediction score for a first member profile and a second prediction score for a second member profile may be generated. Each of the first prediction scores may be based on a function of a first time period in which both a source member profile and the corresponding member profile belonged to the community. A selection is then made between the first member profile and the second member profile based on a comparison of the first prediction score and the second prediction score. A connection recommendation representing the selected member profile is then surfaced to an account of the source member profile.

### TECHNICAL FIELD

The present disclosure generally relates to information retrieval and processing. More specifically, the present disclosure relates to methods, systems and computer program products for generating recommendations based on data derived from a social graph of a social network service.

### BACKGROUND

Online social network services provide members with a mechanism for defining, and memorializing in a digital format, representations of themselves (e.g., member profiles) and their relationships with other people. This digital representation of relationships between members is frequently referred to as a social graph. Many social network services utilize a social graph to facilitate electronic communications and the sharing of information between its users or members. For instance, the relationship between two members of a social network service, as defined in the social graph of the social network service, may determine the access and sharing privileges that exist between the two members. As such, the social graph in use by a social network service may determine the manner in which two members of the social network service can interact with one another via the various communication and sharing mechanisms supported by the social network service.

Some social network services aim to enable friends and family to communicate and share with one another, while others are specifically directed to business users with a goal of facilitating the establishment of professional networks and the sharing of business information. For purposes of the present disclosure, the terms “social network” and “social network service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

With many social network services, members are prompted to provide a variety of personal information, which may be displayed in a member's personal web page. Such information is commonly referred to as “personal profile information”, or simply “profile information”, and when shown collectively, it is commonly referred to as a member's profile. For example, with some of the many social network services in use today, the personal information that is commonly requested and displayed as part of a member's profile includes a member's age (e.g., birth date), gender, contact information, home town, address, the name of the member's spouse and/or family members, a photograph of the member, interests, and so forth. With certain social network services, such as some business network services, a member's personal information may include information commonly included in a professional resume or curriculum vitae, such as information about a person's education, employment history, job skills, professional organizations, and so forth.

Some traditional social network services may behave as a searchable directory of people. In such systems, a user interface (“UI”) may be provided to a member to allow that member to search for other members of the social network to connect. For example, the member may use the UI to enter key terms or other properties in which to search a population of member profiles. Based on the search result, the member may search through the member profiles matching the search criteria to identify member profiles that are of interest. Thus, traditional systems may rely on knowledge and actions from the searching member to identify member profiles that are of interest.

### DESCRIPTION OF THE DRAWINGS

Some embodiments of the technology are illustrated by way of example and not limitation in the figures of the accompanying drawings.

FIG. 1 is a block diagram illustrating various functional components of a suitable computing environment, consistent with some embodiments, for generating member profile recommendations.

FIG. 2 is a data diagram illustrating an example of a social graph that includes member profiles connected to each other through member connections, according to an example embodiment.

FIG. 3 is a data diagram illustrating community overlap data that may be calculated from the social graph, according to an example embodiment.

FIG. 4 is a data diagram illustrating an example of how community overlap data may represent a number of connections shared between member profiles, according to an example embodiment.

FIG. 5 is a data diagram illustrating such a data structure for storing community overlap data associated with the indirect connections of a member profile, according to an example embodiment.

FIG. 6 is a flow diagram illustrating an example method for generating member profile recommendations based on community overlap data derived from a social graph, consistent with some embodiments.

FIG. 7 is a user interface diagram illustrating a user interface for surfacing member profile recommendations to a source member of a social network service, consistent with some embodiments

FIG. 8 is a block diagram of a machine in the form of a computing device within which a set of instructions, for causing the machine to perform any one or more of the methodologies discussed herein, may be executed.

### DETAILED DESCRIPTION

### Overview

The present disclosure describes, among other things, methods, systems, and computer program products, which individually provide functionality for generating recommendations based on data derived from a social graph of a social network service. In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Example embodiments may include systems and methods to generate recommendations based on data derived from social graph data. One type of recommendation that may be generated by example embodiments is a connection recommendation. A connection recommendation may be a recommendation that attempts to solve a link prediction problem by using node (e.g., a member profile) and edge (e.g., member connections) features in the social graph to predict whether an invitation will occur between two nodes that are not directly connected. One type of feature of the social graph that may be used by example embodiments is a community overlap data. “Community overlap data,” as used herein, may be data that represents a measurement of a time period in which two member profiles belonged to the same community (e.g., company, school, group, or any other suitable organization). By way of example and not limitation, some embodiments may use community overlap data that quantifies a time in which two member profiles were employees for the same company.

Accordingly, an example embodiment may relate to methods, systems, and machine readable medium for generating a recommendation based on community overlap data generated from one or more member profiles. That is, some embodiments may generate, for a source member profile, a member profile recommendation of a member profile based on community overlap data related to a time period in which both the source member profile and the member profile belonged to same community. To generate such member profile recommendations, a recommendation engine may, for example, select a community in a social network service to which a plurality of member profiles belong. The plurality of member profiles may include a source member profile, a first member profile, and a second member profile. For clarity of description, the source member profile may be the target of the connection recommendation.

The recommendation engine may then generate a first prediction score for the first member profile and a second prediction score for the second member profile. These prediction scores may each be generated based on a community overlap data between the source member profile and a corresponding member profile. That is, a prediction score may be generated based on a function of a time period in which both the source member profile and the corresponding member profile (e.g., the first and second member profile) belonged to the community.

Based on a comparison of the first prediction score and the second prediction score, the recommendation engine may select between the first member profile and the second member profile. A presentation module may then surface, to an account of the source member profile, a connection recommendation representing the selected member profile. For example, the connection recommendation may be used as part of a web service that suggests to the source member profile other member profiles in which the source member profile may know in real life but have not yet connected through the social networking service.

Example embodiments may provide many practical applications. For example, some systems and methods may leverage information associated with member connections between members of a social network service in order to provide targeted, actionable information to the members, in order to encourage and/or prompt the members to seek additional connections within the social network service, encourage outside users to join the social network service, and other benefits.

In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Other advantages and aspects of the inventive subject matter will be readily apparent from the description of the figures that follows.

### Suitable System

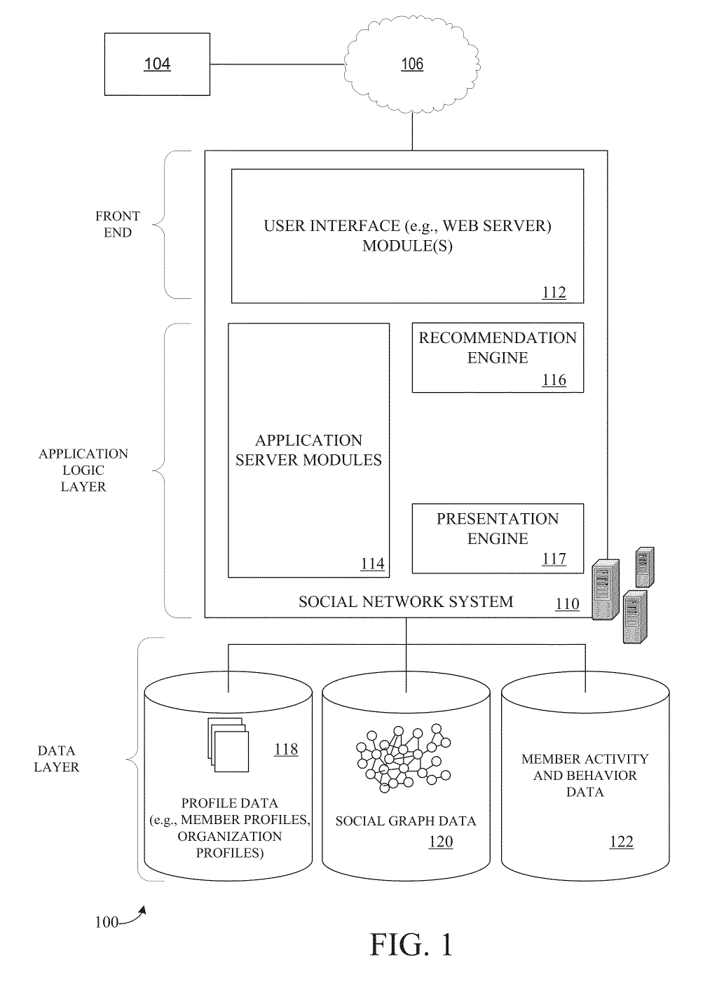

FIG. 1 is a block diagram illustrating various components or functional modules of a social network service 100, consistent with some embodiments. The modules, systems, and/or engines shown in FIG. 1 represent a set of executable software instructions and the corresponding hardware (e.g., memory and processor) for executing the instructions. However, one skilled in the art will readily recognize that various additional functional modules and engines may be used with the social network service 100 to facilitate additional functionality that is not specifically described herein. Furthermore, the various functional modules and engines depicted in FIG. 1 may reside on a single server computer, or may be distributed across several server computers in various arrangements

As shown in FIG. 1, a front end layer of the social network system 110 includes a user interface module (e.g., a web server) 112, which receives requests from various client-computing devices, such as a source member device 104, over a network 106, and communicates appropriate responses to the requesting client devices. For example, the user interface module(s) 112 may receive requests in the form of Hypertext Transport Protocol (HTTP) requests, or other web-based, application programming interface (API) requests. The source member device 104 may be any suitable computing device—such as a personal computer, laptop, cellular phone, smart phone, computing tablet, and the like—executing conventional web browser applications, or applications that have been developed for a specific platform (e.g., operating system, computer system, or some combination thereof).

The network 106 may be any communications network utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, wireless data networks (e.g., Wi-Fi® and WiMax® networks), and so on.

The application logic layer of the social network system 110 includes various application server modules 114, which, in conjunction with the user interface module(s) 112, generates various user interfaces (e.g., web pages) with data retrieved from various data sources in the data layer. With some embodiments, individual application server modules 114 are used to implement the functionality associated with various services and features of the social network service. For instance, the ability to generate connection recommendations for a source member may be service (or services) implemented in independent application server modules 114. Similarly, a variety of other applications or services that are made available to members of the social network service will be embodied in their own application server modules 114. For example, with some embodiments, the social network system 110 includes modules that may individually or in combination provide connection recommendations, such as a recommendation engine 116 and a presentation engine 117. The recommendation engine 116 may be a computer-implemented module configured to generate member profile recommendations. Example embodiments may use a variety of information to generate the connection recommendations, such as data derived from member profiles in a social graph and connections to communities therein.

The presentation engine 117 may be a computer-implemented module configured to generate user interface elements for interacting with the member profile recommendations. For instance, the presentation engine 117 may generate data and logic that, when executed on by one or more processors, causes a client device to display a user interface that depicts the member profile recommendation. In some cases, the presentation engine 117 may use the member profile recommendation to generate user interface elements that may cause the social network service 100 to create a member connection (or initiate the process for forming a member connection) between the source member profile and the member profile represented by the member profile recommendation.

As shown in FIG. 1, the data layer includes several databases, such as a database 118 for storing profile data. Consistent with some embodiments, when a person initially registers to become a member of the social network service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database with reference number 118.

Once registered, a member may invite other members, or be invited by other members, to connect via the social network service. A “member connection, or simply “connection,” may require a bi-lateral agreement by the members, such that both members acknowledge the establishment of the connection. It is to be appreciated that members may “connect” with entities other than member profiles, such as companies, groups, or any other suitable cohort. The various associations and relationships that the members establish with other members, or with other entities represented by date stored in the database 118, are stored and maintained within the social graph, shown in FIG. 1 with reference number 120.

The social network service 100 may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service 100 may host various job listings providing details of job openings with various organizations.

As members interact with the various applications, services and content made available via the social network service, the members' behavior (e.g., content (e.g., profiles) viewed, links selected, messages sent, etc.) may be monitored and information concerning the member's behavior may be stored, for example, as indicated in FIG. 1 by the database with reference number 122. One type of behavior data that may be stored in database 122 is member activity between a member having one member profile with another member having another member profile. As described above, examples of member activities include activities where one member: visits a profile page of a member, messages the member, saves the member in a contact list, introduces the member to another member profile.

Example embodiments may use workflows (e.g., Hadoop® workflows) to implement some portions of the recommendation engine 116. These workflows may execute feature extraction tasks—signals such as the recency of a member connection, company and school overlap, geographical distance, similar ages, and many others (as described in greater detail below)—followed by a model application step. The resulting data model of these workflows may be a key-value store where the key is a member profile identifier and the value is a list of member id, common connection score pairs.

### Example of Social Graph Data

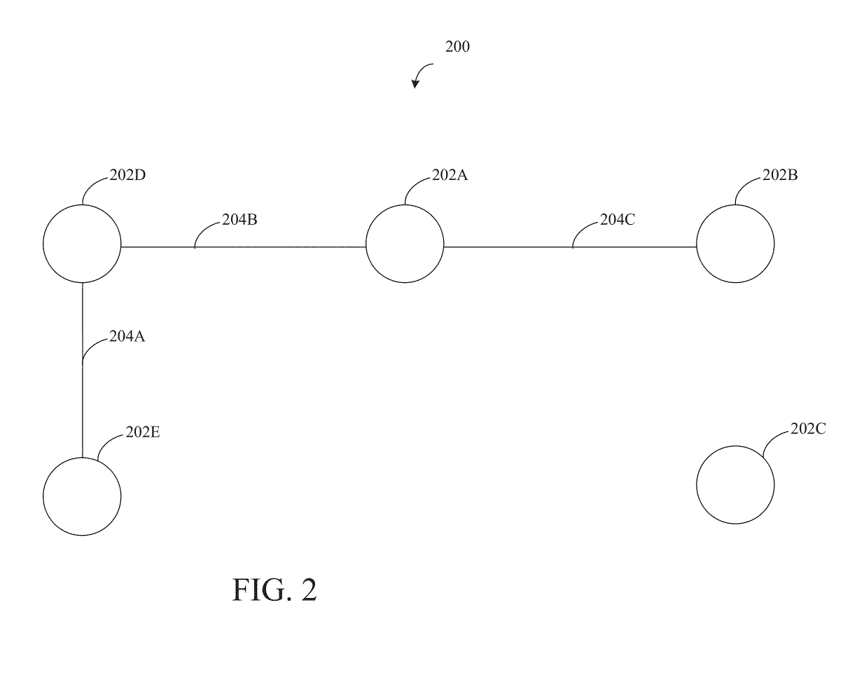

As discussed above, the recommendation engine 116 may be configured to process data from a social graph to generate member profile recommendations. Accordingly, a social graph is now discussed in greater detail. FIG. 2 is a data diagram illustrating an example of a social graph 200 that includes member profiles 202A-E and member connections 204A-C, according to an example embodiment. The member profiles 202A-E, commonly referred to as nodes of the social graph 200, may each represent a member profile of a user of the social network service. For clarity of description, the social graph 200 may be the social graph for the member profile 202A, also referred herein as a “source member profile.”

The member connections 204A-C may be data or logic that represents member connections between member profiles. By way of example and not limitation, a member connection may represent: a member profile accepting a connection request or invite from another member profile; a member profile sending a member connection request or invite to another member; a member importing information from an address book or other database or online location that includes information identifying users or people that are associated with the member; a member following another member; a member viewing the member profile or another member or viewing information identifying potential connections, such as potential connections inferred and/or suggested to the member by the social network service 130; and so on. In some embodiments, a member connection can be unidirectional (e.g., formed by following or subscribing) or bidirectional (e.g., formed by “connecting” or “friending”). It is also not a limitation of this description that two member connections that are deemed “connections” for the purposes of this disclosure are not necessarily connected in real life, but that can be the case.

With respect to a particular member profile, a member connection may be a direct member connection or an indirect member connection. When a member connection of a social graph connects two member profiles, those two member profiles may be referred to as a first-degree connections and the member connection between the two members may be referred to as a first-degree member connection. To illustrate, the member profile 202A is first-degree connections with member profiles 202B and 202D because the member profile 202A is connected to member profile 202B via the member connection 204C and the member profile 202A is connected to member profile 202D via the member connection 204B.

In comparison to a direct connection, an indirect connection is where two member profiles lack a first-degree member connection but a path between the two member profiles exists in the social graph. The number of edges (e.g., member connections) in a minimum path that connects a member profile to another profile is considered the degree of the connection between the member profiles. For example, FIG. 2 shows that the member profile 202E is a second-degree connection to the member profile 202A because the minimum path from 202A to 202E includes two member connections (204B and 204A). The limit on the number of degrees of separation for member connections that a member profile is allowed is typically dictated by the restrictions and policies implemented by the social networking service.

In some cases a member profile may lack a member connection (direct or indirect) to another member connection. This is shown in FIG. 2, as member profile 202A and member profile 202C lack a path of member connections from member profile 202A and 202C.

Thus, a social graph (e.g., the member profiles and connection activities thereof) may be a data structure that illustrates how a member profile (e.g., the source member profile 202A) is “connected” to other member profiles of the social network service. It is to be appreciated that with respect to the social graph 200 shown in FIG. 2, example embodiments may generate a connection recommendation for a source member profile (e.g., 202A) that suggests that that source member profile may want to connect with a non-first degree connection (e.g., member profiles that lack a connection path to the source member (e.g., 202C) or an indirect connection (e.g., 202E)).

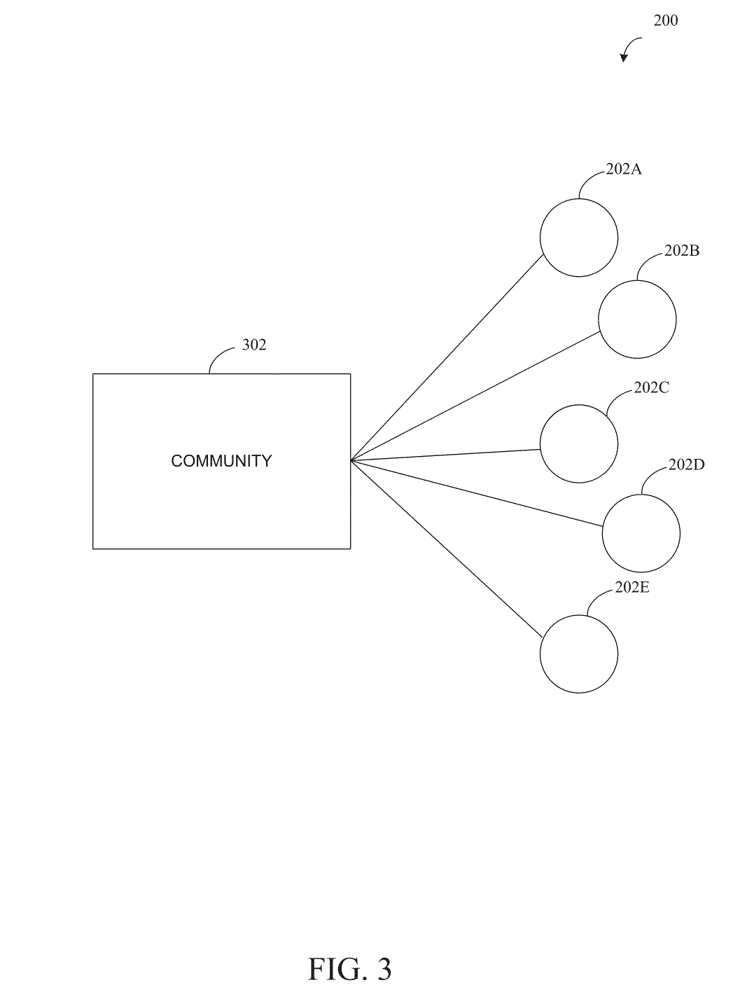

Some embodiments of the social graph 200 may include data in addition to the member profile connections shown in FIG. 2. For example, FIG. 3 is a data diagram illustrating community membership from the member profiles 202A-E, according to an example embodiment. FIG. 3 shows that the social graph 200 may include a community 302 that is connected to member profiles 202A-E. The community 302 may represent an organization such as a business, school, association, or any other organization of people for a business, social, or any other suitable purpose. In some cases, the community 302 may be a separate profile or entity within the social graph. Thus, membership to a community may be stored in the social graph as a relationship data structure linking a member profile and the community profile. In other cases, the community 302 may be a value of a property of a member profile. For example, a member profile may have an Employer property that specifies a company name of the company in which the member works at. Thus, membership to a community may be stored in the social graph as a property or field of the member profile.

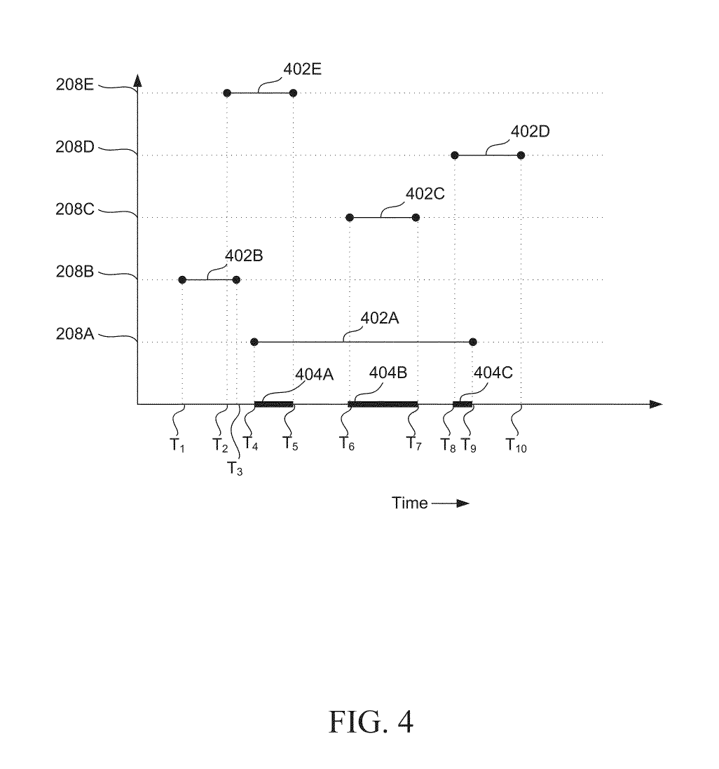

It is to be appreciated that the social graph 200 may further include data specifying when a member profile belonged to a community. For example, FIG. 4 is a diagram illustrating time periods in which member profiles may belong to the community, according to an example embodiment. For example, member profile 202A may be have been a member of the community 302 during time period 402A, the member profile 202B may have been a member of the community 302 during time period 402B, the member profile 202C may have been a member of the community 302 during time period 402C, the member profile 202D may have been a member of the community 302 during time period 402D, the member profile 202E may have been a member of the community 302 during time period 402E, and the member profile 202E may have been a member of the community 302 during the time period 402E. In some embodiments, the time periods 402A-E may be represented by a data structure that specifies a start date and an end date. In some cases, a member profile may still be a member of the community 302. Accordingly, the current date may be used to as the end date.

As FIG. 4 illustrates, some member profiles may have been a member of the community 302 at the same time as member profile 202A. For example, member profile 202C and member profile 202A may overlap in membership to the community 302 during time period T₆ to T₇. Member profile 202D and member profile 202A may overlap in membership to the community 302 during time period T₈ to T₉. Member profile 202E and member profile 202A may overlap in membership to the community 302 during time period T₄ to T₅. It is to be appreciated that some of the community overlap may occur at different time periods of a member profile's membership to the community 302. For example, the community overlap for member profiles 202A and 202C may occur in the middle portion of member profile 202A's membership in the community 302, whereas the community overlap for member profiles 202A and 202E may begin relatively close to the start times for the corresponding member profiles. That is, the start time of the community overlap (T₄) may occur relatively close in time to both the start time for member profile membership 402A (T₄) and the start time for member profile 402E (T₂). In comparison, the community overlap for member profiles 202A and 202D may end relatively close to the end time for one of the member profiles. For example, the end time of the community overlap (T₉) may be relatively close in time to the end time of member profile 202E (e.g., T₁₀).

On the other hand, some member profiles may lack any overlap in membership to the community. For example, the member profile 202B lacks an overlap in time with member profile 202A. That is, the end time for time period 402B (T₃) is before the start time for time period 402A (T₄).

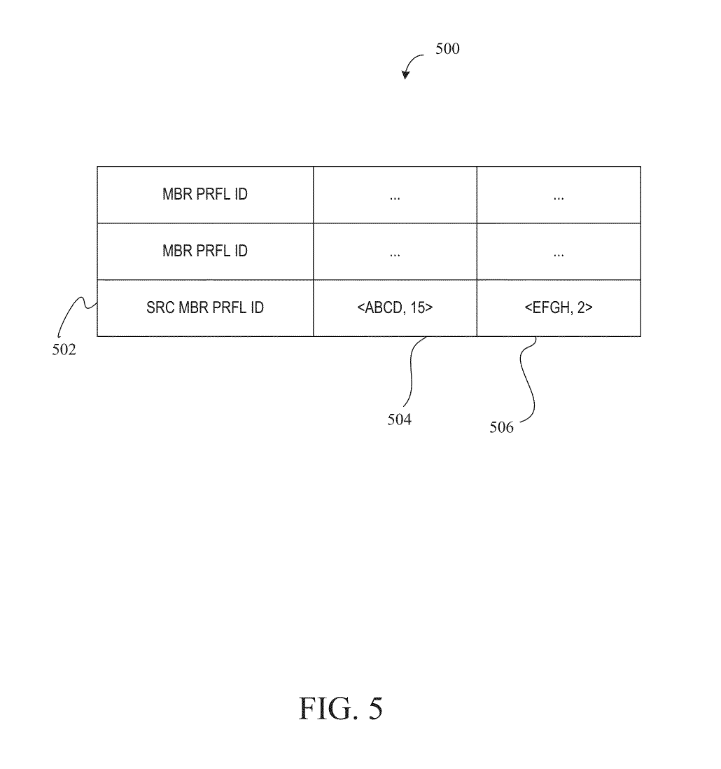

The community overlap data of FIG. 3 may be stored in a data structure that maps an identifier assigned to a member connection to one or more member-identifier-community-overlap-data pairs. FIG. 5 is a data diagram illustrating such a data structure 500 for storing community overlap data associated with the non-first degree connections of a member profile, according to an example embodiment. Conceptually, the data structure 500 may operate as a lookup table, where member profile identifiers may be used as an index to one or more member-identifier-community-overlap-data pairs. For example, the source member profile identifier 502 may be used as an index to retrieve the community overlap data associated with one or more non-first degree connections of the source member profile. For example, the member-identifier-community-overlap-data pair 504 may include a member profile identifier assigned to member profile 202E (e.g., ‘ABCD’) and community overlap data associated with the member profile 202E (e.g., ‘15’). The member-identifier-community-overlap-data pair 506 may include a member profile identifier assigned to member profile 202D (e.g., ‘EFGH’) and community overlap data associated with the member profile 202D (e.g., ‘4’).

### Example Methods of Generating Member Profile Recommendations

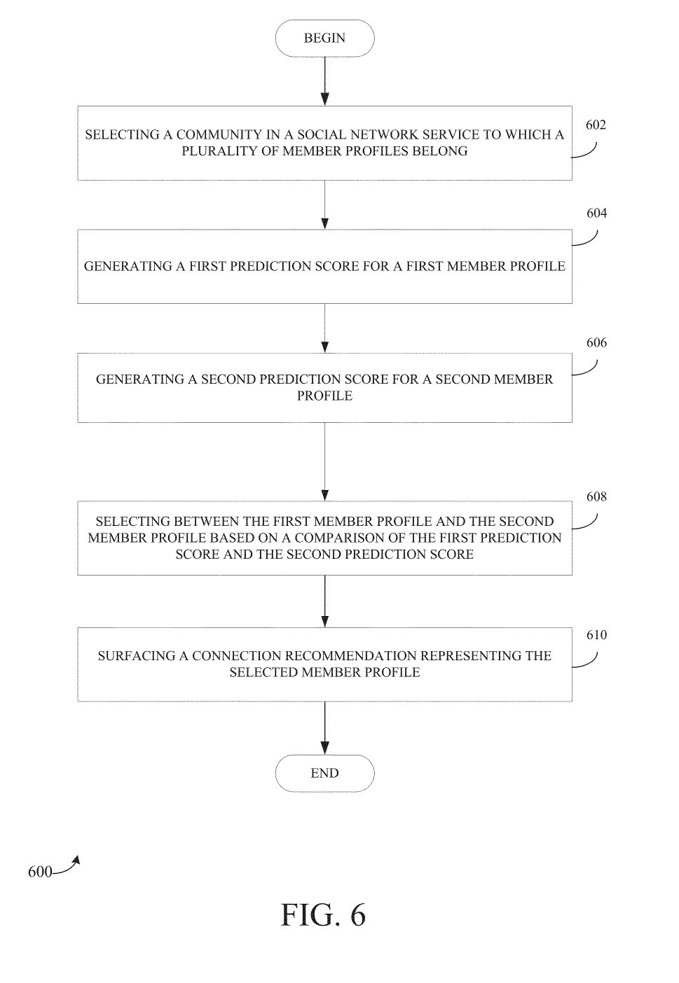

As described herein, the recommendation engine 116 may perform various methods when generating member profile recommendations based on community overlap data derived from a social graph. FIG. 6 is a flow diagram illustrating an example method 600 for generating member profile recommendations based on community overlap data derived from a social graph, consistent with some embodiments. The method 600 may be performed by the recommendation engine 116 and presentation engine 117 and, accordingly, is described herein merely by way of reference thereto. However, it will be appreciated that the method 600 may be performed on any suitable hardware. The method 600 may also be performed by operating on the social graph 200 and data structure shown in FIGS. 2-5 and, accordingly, is described herein merely by way of reference thereto. However, it will be appreciated that the method 600 may be performed on any suitable social graph or data structure.

The method 600 may begin at operation 602 when the recommendation engine 116 selects a community in a social network service to which multiple member profiles belong. For clarity of description, the member profiles of the social network service may include, among others, a source member profile, a first member profile, and a second member profile. The source member profile may be the target of the connection recommendation that the member profile generates as part of the method 600. As described above, the social network service may include data that specifies relationships between member profiles and a community. Thus, the social network service may include data that specifies that, at various points in time, the source member profile, the first member profile, and the second member profile may each belong to the same community, such as a company.

At operation 604, the recommendation engine 116 may then generate a first prediction score for the first member profile. The first prediction score may be based on a function of a first time period in which both the source member profile and the first member profile belonged to the community. It is to be appreciated that the first prediction score may be based further on other features, such as the size of the community, how likely members within a community may connect through the social network service, and the like. These features, as well as others, are described in greater detail below.

At operation 606, the recommendation engine 116 may then generate a second prediction score for the second member profile. Similar to the first prediction score, the second prediction score may be based on a function of a second time period in which both the source member profile and the second member profile belonged to the community. Also, as described above, it is to be appreciated that the second prediction score may be based further on other features, such as the size of the community, how likely members within a community may connect through the social network service, and the like. These features, as well as others, are described in greater detail below.

At operation 608, the recommendation engine 116 may select between the first member profile and the second member profile based on a comparison of the first prediction score and the second prediction score.

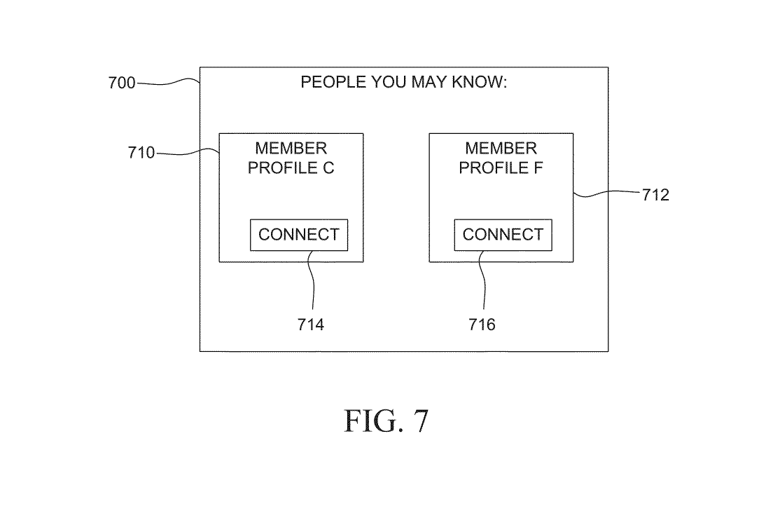

At operation 610, the presentation engine 117 may surface, to an account of the source member profile, a connection recommendation representing the selected member profile. Connection recommendations are discussed in greater detail with respect to FIG. 7.

It is to be appreciated that the method 600 may be executed, all or in part, responsive to the recommendation engine 116 detecting a recommendation event. A recommendation event may be an event that indicates that the recommendation engine 116 is to generate a member profile recommendation for the source member. In some cases, the recommendation engine 116 may detect the recommendation event through an explicit request through an application programmable interface (e.g., a function call or web-based service request) or based on detecting that the source member profile logged into or otherwise accessed the social network. The recommendation event may include data that specifies a source member profile (e.g., a member profile identifier that uniquely identifies the source member profile from the other member profiles in the social network service) for the member profile recommendation.

It is also to be appreciated that the method 600, all or in part, may be executed as a batch process that executes during scheduled downtimes. For example, in some embodiments, the recommendation engine 116 may periodically perform operations 602, 604, 606 to generate or otherwise update prediction tables for various member profiles. Operations 608 and 610 may then be executed when, for example, the recommendation system detects that the source member of the source member profile has accessed a site, web page, user interface configured display connection recommendations.

### Link Prediction Model for Prediction Scores

By way of example and not limitation, example embodiment of the social network service 100 may generate connection recommendation under at least two types of settings: a warm start setting and cold start setting. In a warm start setting, the social network service 100 is given the current member connections between member profiles for a given time, and then generates connection recommendations to predict future connections between member profiles. In other words, the recommendation engine 116 may be given a graph G(t₁)=(V, E(t₁)) at time t₁—where V represents the member profiles in the social graph and E corresponds to member connections between the member profiles at time t₁—and the task is to predict member connections in G(t₂)=(V, E(t₂)), for some time t₂>t₁.

The cold start link prediction problem is another setting that example embodiments of the recommendation engine 116 may be used to predict future member connection for a given node with little or no link information to the given node. This problem is harder because less information exists, but it is important in practice. For example, when a new user joins a social networking service, such as LinkedIn® or Facebook®, it is often times useful to provide recommendations for connections to engage the new member.

The probability of a member connection between two member profiles with a community time overlap (referred to herein as “P(t)”) can be approximated by, for example, a linear model, according to some example embodiments. Accordingly, an example embodiment may use the following linear model to approximate P(t):

$$P ( t ) = {\sum }_{i = 1}^{d} {w}_{i} {x}_{i}$$

where xᵢ denotes a set of features (e.g., [x₁, . . . , x_{d}]) and wᵢ=[w₁, . . . , w_{d}] denotes model parameters. Embodiments of the recommendation engine 116 may consider one or more of the following features on a pair of users to generate a community overlap score:

Time overlap: A length of time in which two member profiles overlap with respect to a membership within a community;

Community size: The size of the community (e.g., the number of member profiles belonging to the company that two member profiles worked at during the same time period);

Community propensity: A measure of how likely employees in a company are friends. An example embodiment may compute this community propensity feature as a function of the number of connections in a community and the community size such as: 2 (number of connections in community)/(community size);

Community average age: Example embodiments may compute the average age of each community;

Community cluster coefficient: The cluster coefficient may be a measurement of how closely users are connected in a community. An example embodiment may compute the cluster coefficient for each community using a function of connections of three or more members (e.g., triplets), such as the following function: number of closed triplets/number of connected triples of vertices;

Node propensity: Node propensity may represent how likely the member profile is connected to another member profile. Example embodiments may use average degree of each member profile as the node propensity; and/or

Join time difference: Example embodiments of the recommendation engine 116 may also consider the join time between two member profiles in calculating a community overlap score. The join time difference feature may model that an employee makes many connections when the employee first joins a company, while the probability of making connections may decay as the employee works longer in the company. Therefore, with the same overlapping time, the probability of a connection between two employees also depends on the difference in the join time.

### Example User Interface

As described herein, the presentation engine 117 may surface content from member profiles selected by the recommendation engine 116. In the case of connection recommendations, the content from the member profile may be presented in conjunction with actionable display elements that may, in some cases, cause the social network service to create a direct member connection between the source member profile and a member profile surfaced by the presentation engine 117.

FIG. 7 is a user interface diagram illustrating a user interface for surfacing member profile recommendations to a source member of a social network service, consistent with some embodiments. FIG. 7 depicts a suggestion module 700 that surfaces (e.g., displays) content derived from member profiles of the social network service that suggest member connections 710-712 to a source member. The connection recommendations 710-712 may be data or logic that may represent content derived from member profiles selected by the recommendation engine 116. For clarity of description, not limitation, connection recommendation 710 may include content derived from member profile 202C of FIGS. 2 and 3, and connection recommendation 712 may include content derived from member profile 202F of FIGS. 2 and 3. In some cases, the recommendation engine 116 may determine that the member profile represented by the member connections 710 and 712 (e.g., member profile 202C and member profile 202F, respectively) are likely to be of interest to the source member (e.g., member profile 202A) because the member profiles represented by the member connections 710 and 712 exhibit features of community overlap data discussed above.

FIG. 7 shows that the connection recommendations 710 and 712 each include connection activators 714 and 716, respectively. A connection activator may be an actionable user interface element that causes, when activated by the source member, the social network service to send an invitation to the member profile corresponding to the connection recommendation. For example, responsive to the source member activating the connection activator 714, the social network service 100 may then send an invitation to the member profile 202C to form a member connection with the source member profile (e.g., member profile 202A).

The presentation engine 117 may surface the suggestion module 700 within a user interface the source member uses to access the social network service. For example, the presentation engine 117 may surface the suggestion module 700 within a sidebar or rail location within a member profile page associated with the source member profile.

It is to be appreciated that the suggestion module 700 shown in FIG. 7 is provided to illustrate an example embodiment and should not be interpreted as limiting any aspect of other example embodiments contemplated by this disclosure. For example, other embodiments may display more or less connection recommendations (e.g., three connection recommendations). Further, according to some embodiments, the member profiles represented by the connection recommendations may differ, depending on the implementation of the recommendation engine 116 discussed above. For example, some embodiments may utilize features of community overlap data that weights the importance of the community overlap of a non-first degree member profile.

### Example Computer Systems

The various operations of example methods described herein may be performed, at least partially, by one or more processors that are temporarily configured (e.g., by software) or permanently configured to perform the relevant operations. Whether temporarily or permanently configured, such processors may constitute processor-implemented modules, engines, objects or devices that operate to perform one or more operations or functions. The modules, engines, objects and devices referred to herein may, in some example embodiments, comprise processor-implemented modules, engines, objects and/or devices.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

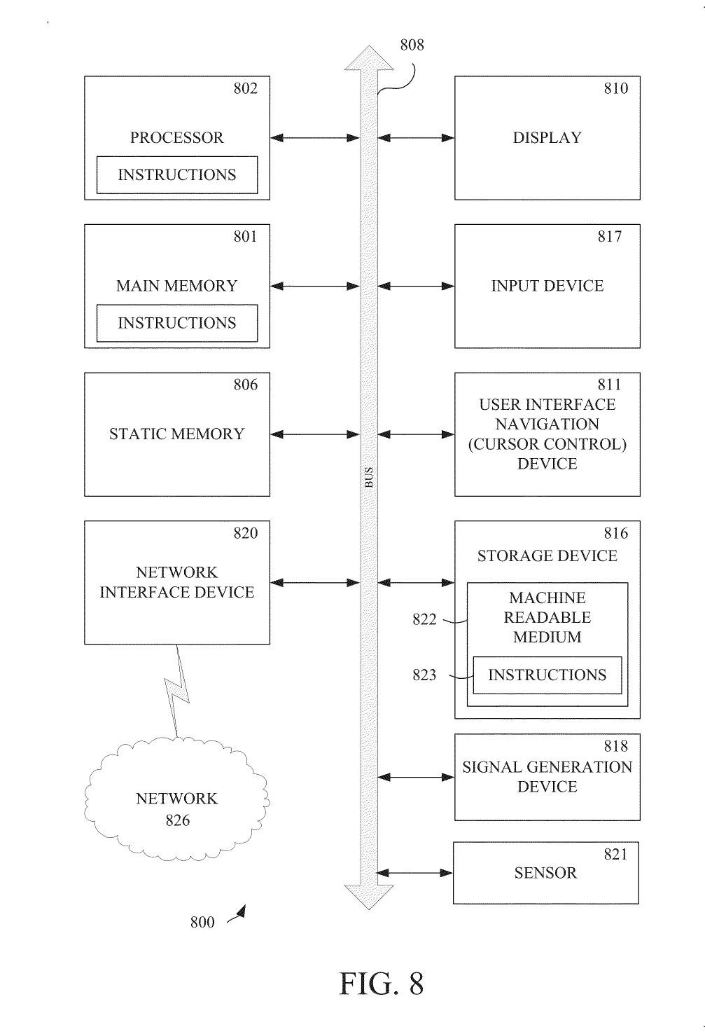

FIG. 8 is a block diagram of a machine in the form of a computer system or computing device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In some embodiments, the machine will be a desktop computer, or server computer, however, in alternative embodiments, the machine may be a tablet computer, a mobile phone, a personal digital assistant, a personal audio or video player, a global positioning device, a set-top box, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a display unit 810, an alphanumeric input device 812 (e.g., a keyboard), and a user interface (UI) navigation device 814 (e.g., a mouse). In one embodiment, the display, input device and cursor control device are a touch screen display. The computer system 800 may additionally include a storage device 816 (e.g., drive unit), a signal generation device 818 (e.g., a speaker), a network interface device 820, and one or more sensors, such as a global positioning system sensor, compass, accelerometer, or other sensor.

The drive unit 816 includes a machine-readable medium 822 on which is stored one or more sets of instructions and data structures (e.g., software 824) embodying or utilized by any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 824 may further be transmitted or received over a communications network 826 using a transmission medium via the network interface device 820 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although some embodiments has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A computer-implemented method comprising:
selecting a community in a social network service to which a plurality of member profiles belong, the plurality of member profiles including a source member profile, a first member profile, and a second member profile;
generating a first prediction score for the first member profile and a second prediction score for the second member profile, the first prediction score being based on a function of a first time period in which both the source member profile and the first member profile belonged to the community, and the second prediction score being based on a function of a second time period in which both the source member profile and the first member profile belonged to the community;
selecting between the first member profile and the second member profile based on a comparison of the first prediction score and the second prediction score; and
surfacing, to an account of the source member profile, a connection recommendation representing the selected member profile.

2. The computer-implemented method of claim 1, wherein selecting between the first member profile and the second member members comprises ranking each of the first member profile and second member profile based on respective prediction scores, and selecting a highest ranked member profile.

3. The computer-implemented method of claim 1, further comprising, responsive to detection of an activation of the member connection recommendation, communicating a connection invitation to the selected member profile, the connection invitation being actionable message configured to cause the network system to form a member connection between the source member profile and the selected member profile.

4. The computer-implemented method of claim 1, generating the first prediction score and the second prediction score is based further on features of the community.

5. The computer-implemented method of claim 4, wherein the features of the community include at least one of: a community size, a community propensity, a community average age, a community cluster coefficient, a node propensity, or a join time difference.

6. The computer-implemented method of claim 4, wherein the first time period and the second time period overlap in time.

7. The computer-implemented method of claim 1, further comprising:
identifying that the source member profile includes a community membership relationship to the community; and
selecting the first member profile and the second member profile based on the first member profile and the second member profile each having a community membership relationship to the community.

8. The computer-implemented method of claim 1, wherein the first prediction score is of a preferred value compared to the second predication score based on determining that the first time period is greater than the second time period.

9. The computer-implemented method of claim 1, wherein the source member profile is a non-first degree connection with the first member profile, and the source member profile is a non-first degree connection with the second member profile.

10. The computer-implemented method of claim 1, further comprising filtering out first degree connections of the source member profile.

11. A computer-implemented system comprising:
a recommendation engine implemented by at least one processor and configured to:
select a community in a social network service to which a plurality of member profiles belong, the plurality of member profiles including a source member profile, a first member profile, and a second member profile;
generate a first prediction score for the first member profile and a second prediction score for the second member profile, the first prediction score being based on a function of a first time period in which both the source member profile and the first member profile belonged to the community, and the second prediction score being based on a function of a second time period in which both the source member profile and the first member profile belonged to the community;
select between the first member profile and the second member profile based on a comparison of the first prediction score and the second prediction score; and
a presentation engine implemented by the at least one processor and configured to surface, to an account of the source member profile, a connection recommendation representing the selected member profile.

12. The computer-implemented system of claim 11, wherein the recommendation engine is configured to select between the first member profile and the second member members comprises ranking each of the member profiles based on respective predication scores, and select a highest ranked member profile.

13. The computer-implemented system of claim 11, wherein the presentation engine is further configured to, responsive to detection of an activation of the member connection recommendation, communicate a connection invitation to the selected member profile, the connection invitation being actionable message configured to cause the network system to form a member connection between the source member profile and the selected member profile.

14. The computer-implemented system of claim 11, wherein the first prediction score and the second predication score are generated based on features of the community.

15. The computer-implemented system of claim 14, wherein the features of the community include at least one of: a community size, a community propensity, a community average age, a community cluster coefficient, a node propensity, or a join time difference.

16. The computer-implemented system of claim 14, wherein the first time period and the second time period overlap in time.

17. The computer-implemented system of claim 11, wherein the recommendation engine is further configured to:
identify that the source member profile includes a community membership relationship to the community; and
select the first member profile and the second member profile based on the first member profile and the second member profile each having a community membership relationship to the community;

18. The computer-implemented system of claim 17, wherein the additional score is of a preferred value based on an overlap in time between the first time period and the third time period is greater than an overlap in time between the first time period and the second time period.

19. The computer-implemented system of claim 11, wherein the source member profile is a non-first degree connection with the first member profile, and the source member profile is a non-first degree connection with the second member profile.

20. A non-transitory computer-readable medium storing executable instructions thereon, which, when executed by a processor, cause the processor to perform operations comprising:
selecting a community in a social network service to which a plurality of member profiles belong, the plurality of member profiles including a source member profile, a first member profile, and a second member profile;
generating a first prediction score for the first member profile and a second prediction score for the second member profile, the first prediction score being based on a function of a first time period in which both the source member profile and the first member profile belonged to the community, and the second prediction score being based on a function of a second time period in which both the source member profile and the first member profile belonged to the community;
selecting between the first member profile and the second member profile based on a comparison of the first prediction score and the second prediction score; and
surfacing, to an account of the source member profile, a connection recommendation representing the selected member profile.
